(19) United States
(12) Patent Application Publication
(10) Pub. No.: US 2026/0104857 A1
(43) Pub. Date: Apr. 16, 2026

(54) QUANTIZING LOW-PRECISION NEURAL NETWORKS FOR LOSSLESS ACCUMULATION

(71) Applicants: Advanced Micro Devices, Inc., Santa Clara, CA (US); XILINX, INC., San Jose, CA (US)

(72) Inventors: Ian Charles COLBERT, San Diego, CA (US); Thomas Bernd PREUSSER, Dresden (DE); Yaman UMUROGLU, Stockholm (SE)

(21) Appl. No.: 18/915,206

(22) Filed: Oct. 14, 2024

(51) Int. Cl. G06F 7/544; G06F 7/485; G06F 7/487; G06F 7/556

(52) U.S. Cl. CPC G06F 7/5443; G06F 7/485; G06F 7/4876; G06F 7/556

(57) ABSTRACT

Embodiments herein relate to training, calibrating, or preparing quantized neural networks for lossless low-precision accumulation with floating-point dot product operands. This includes an improvement in training low-precision floating-point neural networks for a certain accumulator bit width. The accumulator-aware weight quantization methodology yields floating-point weights that avoid arithmetic errors caused by overflow, underflow, and rounding, among other common problems when accumulated into low-precision accumulators during dot products with input activations of known data formats. This is implemented by imposing constraints on the values of the exponents and mantissas used to represent the weights of the neurons of the neural network.

### TECHNICAL FIELD

The embodiments presented relate to quantized neural networks in machine learning (ML). A quantized neural network is a type of neural network where the weights and activations are converted from floating-point representations to lower-bit representations. The quantization process reduces the model's memory usage and computational load, enabling faster inference and lower power consumption.

### BACKGROUND

Accumulation in a quantized neural network refers to summing the results of multiple quantized operands, which are typically the products resulting from a preceding multiplier. A quantized neural network is a type of neural network where the weights and activations are converted from high-precision floating-point representations to lower bit representations. The quantization process reduces the model's memory usage and computational load, enabling faster inference and lower power consumption.

During a forward pass, the weights of the neurons of the quantized neural network are multiplied with the activations of the quantized neural network and their products are summed. During a backward pass, the gradient computations are calculated and the weights of the neurons are updated. In quantized neural networks, the input weights and intermediate results are represented with low precision, such as 8-bit integers. This reduced precision can introduce rounding errors and quantization noise, which can accumulate over many operations and affect the network's accuracy.

### SUMMARY

According to some embodiments, a method including: receiving a plurality of input vectors of floating-point weights for a quantized neural network; determining an exponent value, based on a target bit width of an accumulator and a known data format used for a vector of activation values, for each weight of the plurality of input vectors, and generating a first vector of the exponent values; determining a mantissa value, based on a target bit width of the accumulator, and the known data format used for the vector of activation values, for each weight of the plurality of vectors, and generating a second vector of mantissa values; combining the first vector of exponent values and the second vector of mantissa values; and performing a mathematical operation between the combined vectors and the vector of activation values in a MAC unit

According to some embodiments, a system including 7one or more processors; and one or more memories configured to store an application, which, when executed by a combination of the one or more processors, causes the combination of the one or more processors to perform an operation, the operation including: receiving a plurality of input vectors of floating-point weights for a quantized neural network; determining an exponent value, based on a target bit width of an accumulator and a known data format used for a vector of activation values, for each weight of the plurality of input vectors, and generating a first vector of the exponent values; determining a mantissa value, based on a target bit width of the accumulator and the known data format used for the vector of activation values, for each weight of the plurality of vectors, and generating a second vector of mantissa values; combining the first vector of exponent values and the second vector of mantissa values; and performing a mathematical operation between the combined vectors and a vector of activation values in the accumulator.

According to some embodiments, a computer-readable storage medium having computer-readable program code embodied therewith, the computer-readable program code executable by one or more computer processors to: receive a plurality of input vectors of floating-point weights for a quantized neural network; determine an exponent value, based on a target bit width of an accumulator, and a known data format used for a vector of activation values, for each weight of the plurality of input vectors, and generating a first vector of the scaled values; determine a mantissa value, based on a target bit width of the MAC and the known data format used for the vector activation values, for each weight of the plurality of vectors, and generating a second vector of mantissa values; combine the first vector of exponent values and the second vector of mantissa values; and perform a mathematical operation between the combined vectors and the vector of activation values in the MAC unit.

### BRIEF DESCRIPTION OF DRAWINGS

FIG. 1 illustrates a neural network, according to some embodiments.

FIG. 2 illustrates a dataflow of a quantization system, according to some embodiments.

FIG. 3 illustrates a flowchart for a quantization system, according to some embodiments.

FIG. 4 illustrates an accumulator, according to some embodiments.

FIG. 5 illustrates a flowchart for constraining weights, according to some embodiments.

FIG. 6 illustrates the weights being constrained, according to some embodiments.

FIG. 7 illustrates a flowchart for constraining weights, according to some embodiments.

### DETAILED DESCRIPTION

As mentioned above, training quantized neural networks can lead to challenges in maintaining the neural network's accuracy. Low-precision accumulation refers to the practice of performing arithmetic operations, such as multiplication and addition, in a reduced precision format during either forward or backward passes in training. Low-precision accumulation improves the efficiency of neural networks. By training neural networks with quantization in mind, models can be efficient but also more accurate.

Embodiments herein relate to training or preparing quantized neural networks for low-precision accumulation with floating-point dot products. This includes an improvement in training low-precision floating-point neural networks for a certain accumulator bit width, as well as post-training quantization, where weights are directly cast and calibrated according to our constraints. The improved training and post training embodiments avoid arithmetic errors caused by overflow, underflow, or rounding, among other common problems when implementing low-precision accumulators. This improvement is implemented by imposing accumulator-aware constraints on the values of the exponents and mantissas used to represent the weights of the neurons of the neural network. In some embodiments, a Kulisch accumulator of a certain bit width is used where the results of the floating-point dot products of the weights of the neurons are accumulated into a register of reduced size relative to an assumed multiply-accumulator (MAC) functioning without such constraints in mind.

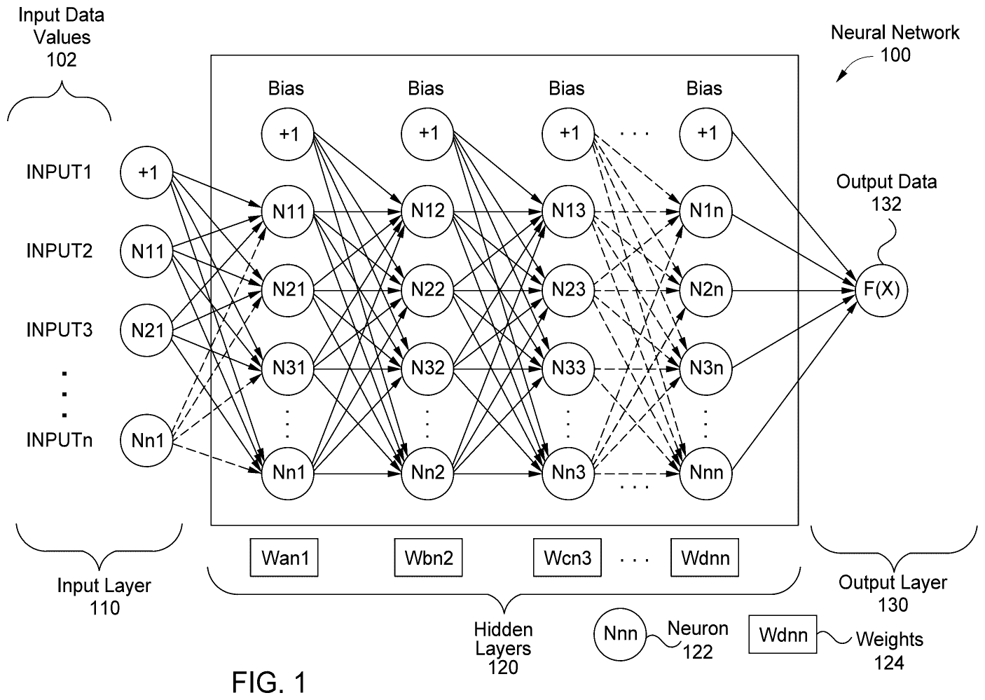

FIG. 1 illustrates a generalized diagram of a neural network 100 that includes less computationally intensive nodes. The neural network 100 is a data model that implements one of a variety of types of a neural network. Examples of the neural network are one of multiple types of convolutional neural networks and recurrent neural networks. The neural network 100 classifies data in order to provide output data 132 that represents a prediction when given a set of inputs. To do so, the neural network 100 uses an input layer 110, one or more hidden layers 120, and an output layer 130. Each of the layers 110, 120 and 130 includes one or more neurons 122 (or nodes 122). Each of these neurons 122 receives input data such as the input data values 102 in the input layer 110. In the one or more hidden layers 120 and the output layer 130, each of the neurons 122 receives input data as output data from one or more neurons 122 of a previous layer. These neurons 122 also receive one or more weight values 124 that are combined with corresponding input data.

It is noted that in some implementations, the neural network 100 includes only a single layer, rather than multiple layers. Such single-layer neural networks are capable of performing computations for at least edge computing applications. In other implementations, the neural network 100 has a relatively high number of hidden layers 120, and the neural network 100 is referred to as a deep neural network (DNN). Each of the neurons 122 of the neural network 100 combines a particular received input data value with a particular one of the weight values 124. Typically, the neurons 122 use matrix multiplication, such as General Matrix Multiplication (GEMM) operations, to perform the combining step. Circuitry of a processor (not shown) performs the steps defined in each of the neurons 122 (or nodes 122) of the neural network 100. For example, the hardware, such as circuitry, of the processor performs at least the GEMM operations of the neurons 122. In some implementations, the circuitry of the processor is a data-parallel processing unit that includes multiple compute units, each with multiple lanes of execution that supports a data-parallel microarchitecture for processing workloads.

The input layer 110 includes the initial input values 102 for the neural network 100. During training, these initial input values 102 are predetermined values used for training the neural network 100. The bias (“Bias”) values represent a difference or shift of the prediction values provided by the neurons 122 from their intended values. A relatively high value for a particular bias indicates that the neural network 100 is assuming more than accurately predicting output values that should align with expected output values. A relatively low value for the particular bias indicates that the neural network 100 is accurately predicting output values that should align with expected output values. The weight values 124 indicate an amount of influence that a change of a corresponding input data value has on a change of the output data value of the particular neuron. A relatively low weight value indicates a change of a corresponding input data value provides little change of the output value of the particular neuron. In contrast, a relatively high weight value indicates a change of the corresponding input data value provides a significant change of the output value of the particular neuron.

The neurons 122 of the hidden layers 120, other than a last hidden layer, are not directly connected to the output layer 130. Each of the neurons 122 has a specified activation function such as a unit step function, which determines whether a corresponding neuron will be activated. An example of the activation function is the rectified linear unit (ReLU) activation function, which is a piecewise linear function used to transform a weighted sum of the received input values into the activation of a corresponding one of the neurons 122. When activated, the corresponding neuron generates a non-zero value, and when not activated, the corresponding neuron generates a zero value.

The activation function of a corresponding one of the neurons 122 receives the output of a matrix multiply and accumulate (MAC) operation. This MAC operation of a particular neuron of the neurons 122 combines each of the received multiple input data values with a corresponding one of multiple weight values of the weight values 124. The number of accumulations, which can be represented by K, performed in the particular neuron before sending an output value to an activation function can be a relatively high number. Here, K is a positive, non-zero integer that is a relatively high value.

In some implementations, a designer uses an application programming interface (API) to specify multiple characterizing parameters of the neural network 100. Examples of these parameters are a number of input data values 102 for the input layer 110, an initial set of weight values for the weights 124, a number of layers of the hidden layer 120, a number of neurons 122 for each of the hidden layers 120, an indication of an activation function to use in each of the hidden layers 120, a loss function to use to measure the effectiveness of the mapping between the input data values 102 and the output data 132, and so on. In some implementations, different layers of the hidden layers 120 use different activation functions.

The training process of the neural network 100 is an iterative process that finds a set of values for the weight values 124 used for mapping the input data values 102 received by the input layer 110 to the output data 132. The specified loss function evaluates the current set of values for the weight values 124. One or more of forward propagation and backward propagation used with or without gradient descent is used to minimize the cost function by inspecting changes in the bias, the previous activation function results, and the current set of values for the weight values 124.

To create less computationally intensive neurons 122 for the neural network 100, quantization is used during training and inference. For example, the processor replaces a 32-bit floating-point input data value with an 8-bit floating-point input data value to be used in an integer matrix multiply and accumulate (MAC) operation of a corresponding one of the neurons 122. However, such a step commonly assumes the accumulator portion of the MAC operation would still use a 32-bit floating point bit width.

As described earlier, the number of accumulations, which can be represented by K, can be a relatively high number. This number of accumulations is performed in the corresponding one of the neurons 122 before sending an output value to an activation function. Therefore, if the accumulator bit width is reduced, numerical overflow is possible during the relatively high number K of accumulations performed for the MAC operation of the corresponding one of the neurons 122.

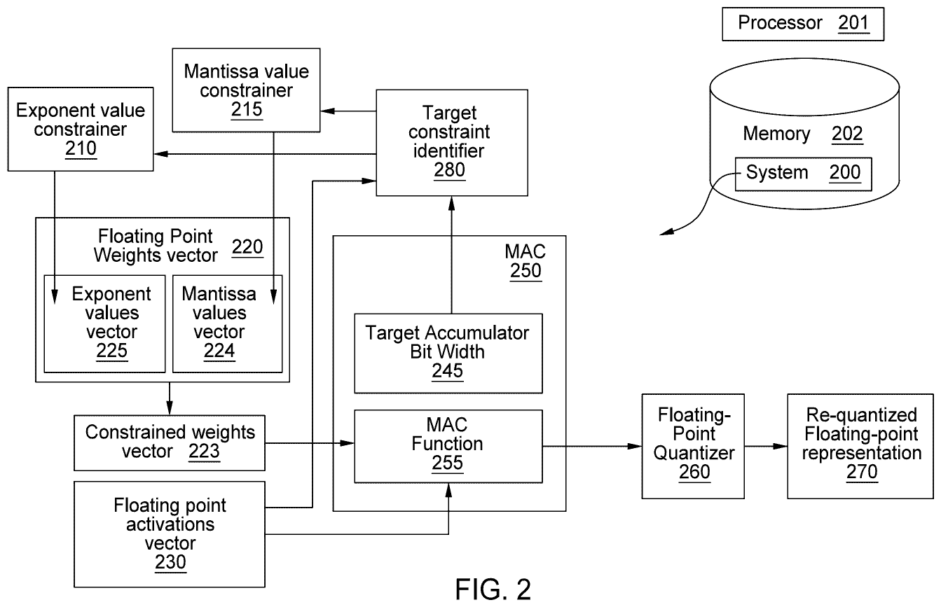

FIG. 2 illustrates a system 200 that constrains the weights of a neuron, ensuring efficiency and accuracy of the quantized neural network 100.

The system 200 can be implemented on a computing system with a processor 201, and a memory 202. The processor 201 generally retrieves and executes programming instructions stored in the memory 202. The processor 201 is representative of a single central processing unit (CPU), multiple CPUs, a single CPU having multiple processing cores, graphics processing units (GPUs) having multiple execution paths, specialized AI hardware accelerators (e.g., systems of a chip), and the like.

The memory 202 generally includes program code for performing various functions related to use of the system 200. The program code is generally described as various functional “applications” or “modules” within the memory 202, although alternate implementations may have different functions and/or combinations of functions. Within the memory 202, the system 200 facilitates constraining values of the quantized neural network, improving efficiency and accuracy of quantized neural networks. This is discussed further, below.

The system 200 includes a MAC 250 that has a target accumulator bit width 245. The system 200 uses a target constraint identifier 280 to identify the target accumulator bit width 245 and the data format of the data contained in the floating-point activations vector 230. Using this information, the system 200 constrains input values to the MAC 250 accordingly. Constraining can be facilitated through mathematical operations such as division, subtraction, or sparsification. For example, the target constraint identifier 280 can communicate the target accumulator bit width 245 as well as the data format of the data contained in the floating-point activations vector 230 to an exponent value constrainer 210 and to a mantissa value constrainer 215. The exponent value constrainer 210 uses the information received from the target constraint identifier 280 to constrain the exponent values of the weights of the neurons received by the MAC 250. Likewise, the mantissa value constrainer 215 constrains the mantissa values of the weights of the neurons received by the MAC 250.

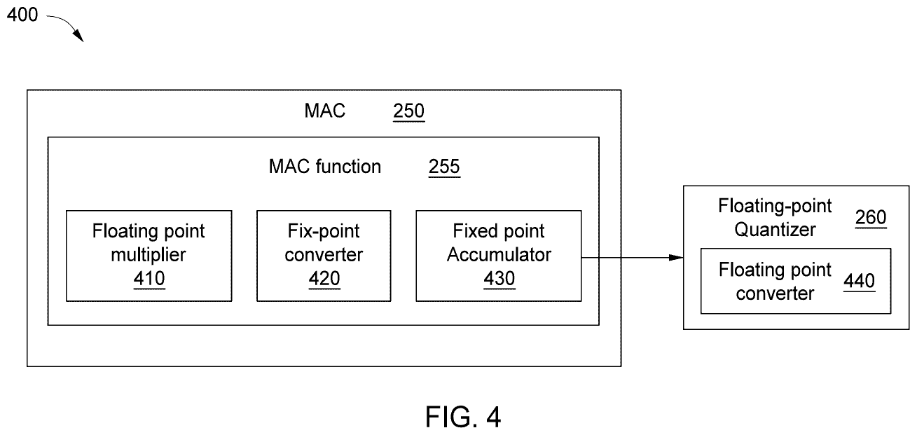

The exponent values and mantissa values are components of weights making up a floating-point weights vector 220. The exponent value constrainer 210 and the mantissa value constrainer 215 constrain the values of the exponent values making up an exponent values vector 225 and the mantissa values making up a mantissa values vector 224, respectively. Collectively, the constrained mantissa values vector 224 and constrained exponent values vector 225 combine to produce a constrained weights vector 223. The constrained weights vector 223 contains the constrained exponent values and constrained mantissa values computed by the exponent value constrainer 225 and mantissa value constrainer 215 from the floating-point weights vector 220. The constrained weights vector 223 and a floating-point activations vector 230 are taken as input by the MAC 250. The MAC 250 is used as a catch-all to encompass the multiply-accumulate (MAC) process. The MAC 250 combines its inputs (the constrained weights vector 223 and the floating-point input activation vector 230) and sums the products of the combined inputs to produce a summed value. Once received by the MAC 250, a MAC function 255 within the MAC 250 accumulates the inputs, and outputs the accumulated value to a floating-point quantizer 260, which outputs a re-quantized floating-point representation 270 of the accumulated values for the neural network 100 to use in proceeding layers, among other things. This is described in more detail in FIG. 4.

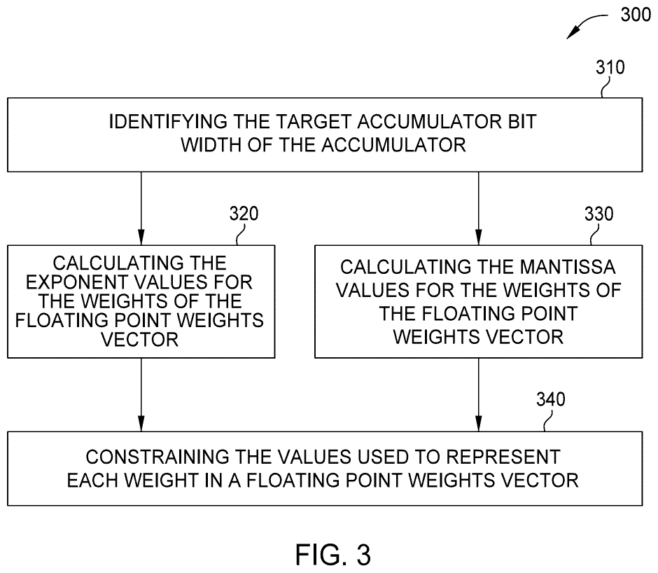

The exponent values vector 225 and the mantissa values vector 224 can be two separate vectors of values derived from the floating-point weight values of the floating-point weights vector 220. The exponent value constrainer 210 and the mantissa value constrainer 215 calculate constrained values with the target accumulator bit width 245 in mind, as well as with awareness of the data format of the data contained in the floating-point activations vector 230. This calculation process is further discussed in FIG. 3.

The floating-point weights vector 220 represents a set of connection strengths from primary inputs or preceding layers between neurons of a different layers of the network. These representations of connection strengths can be represented as floating-point numbers that can control how input signals are transformed as they pass through the network. Floating-point representations such as 32-bit (single precision) or 16-bit (half precision) formats, may be used, as they provide a wide range of values with a balance between precision and the ability to represent a range of small to large numbers. Such flexibility in representation provides an improvement in training neural networks, as weights can be adjusted based on gradients computed through backpropagation, at varying rates, to minimize the error in the network's predictions, allowing the network to learn complex patterns in the data.

The floating-point representation of each weight in the floating-point weights vector 220 may be divided into three components: the sign (indicating whether the number is positive or negative), the mantissa (or the significand, which represents the significant digits of the number), and the exponent (which scales the number by a power of two). This structure allows floating-point numbers to represent a vast range of values, but also means that the absolute step size, with which the number can be represented, depends on the number's magnitude. For example, smaller numbers can be represented at a more fine-grained step size than larger numbers, within the limits of the floating-point format used.

In the context of quantization, the exponent values vector 225 is a vector of values that map each floating-point weight to a lower precision, such as 8-bit integers. The exponent values vector 225 contains numbers calculated by the exponent value constrainer 210, which applies constraint factors to the weight values of the floating-point weights vector 220, mapping those values from their floating-point representation to a lower precision format, adjusting the numbers of the weights to fit within the constraint determined by the target accumulator bit width 245 and the data format of the data contained in the floating-point activations vector 230.

The mantissa values vector 224 includes values describing the bit width or the precision level of the floating-point weights of the weights of the floating-point weights vector 220. The mantissa values vector 224 represents the level of detail or granularity with which each weight in the floating-point weights vector 220 can be represented after quantization. For example, in mixed-precision training, different layers of the neural network may use weights with different levels of precision (e.g. some layers may use 4-bit floating-point formats while others may use 8-bit floating-point formats). A mantissa values vector, such as the mantissa values vector 224, may store this information indicating how precise each weight in the network is intended to be. For example, an 8-bit data format can mean that weights can be represented using 256 distinct values, while a 16-bit data format can allow for 65,537 values.

The interplay between exponent and mantissa can improve the neural network deployment, especially in quantized or mixed environments. Together, the exponent values vector 225 and the mantissa values vector 224 ensure that when the floating-point weights vector 220 is quantized, the resulting quantized weights from the constrained weights vector 223 can still function effectively within the neural network. The exponent values ensure that weights, despite being in a lower precision format, can still represent a wide range of values accurately, preserving the network's ability to make accurate predictions. The mantissa values of the mantissa values vector 224 can help determine the trade-off between computational efficiency and accuracy. For example, a lower precision might lead to faster computation and reduced memory usage, but to ensure accuracy isn't heavily impacted, there are benefits from careful management of constraining values to avoid significant loss of information.

The exponent values of the exponent values vector 225 and the mantissa values of the mantissa values vector 224 can be calculated differently to fit within the constraints identified by the target bit width identifier 280 and the data format of the data contained in the floating-point activations vector 230. Collectively, the constrained/calculated values of both vectors make up the constrained weights vector 223.

Exponent values of the exponent values vector 225 are constrained, as discussed above. This constraint can be determined by the identified target accumulator bit width 245 of the MAC 250 and the data format of the data contained in the floating-point activations vector 230.

Mantissa values of the mantissa values vector 224 can also be determined by the target accumulator bit width 245, and the data format of the data contained in the floating-point activations vector 230.

In some embodiments, this described framework supports quantization-aware training (QAT). QAT allows the neural network to learn and adapt its parameters with quantization in mind. This approach ensures that the network remains robust despite the reduced precision. Additionally, during QAT, the constraining can be fine-tuned (e.g. the exponent value constrainer 210 and the mantissa value constrainer 215 adjust their calculations according to feedback from the neural network) to minimize impact on performance while maximizing efficiency. The calculated constraint levels can be used during inference to efficiently process data with minimum loss of accuracy and maximized performance.

The MAC 250 receives the constrained weights vector 223 and the floating-point activation functions vector 230 as input. The floating-point activation functions vector 230 contains activation functions, which are mathematical functions applied to the output of a neuron of a neural network. Activation functions introduce nonlinearity to a network, allowing the network to learn and model complex patterns in the data. Without activation functions, neural networks would behave as simple linear models, regardless of the neural networks' depth. Without activation functions, the neural network would not be able to handle intricate, nonlinear relationships typically present in real world data. Activation functions enable the network to capture and represent nonlinear patterns by transforming the raw weighted sum of inputs into a nonlinear output.

There are several types of activation functions commonly used in neural networks. These activation functions include but are not limited to a sigmoid function, rectified linear unit function (ReLU), the tanh function, and the softmax function, among others.

The sigmoid function maps input values to the range (0,1) making it useful for binary classification tasks. It is defined as

$$σ ( x ) = \frac{1}{1 + {e}^{- x}} .$$

However the sigmoid function suffers from issues such as vanishing gradients, which can slow down or stall deep networks. The ReLU function is defined as ReLU(x)=max(0, x). It is a simple and fast function that has become popular in deep learning. ReLU helps alleviate the vanishing gradient problem by allowing gradients to pass through unchanged for positive values. However the ReLU function can present the problem of “dead neurons” for negative inputs. The tanh function is defined as

$$tanh ( x ) = \frac{2}{1 + {e}^{- 2 x}} - 1$$

and maps input values to the range (−1,1). Similar to the sigmoid function, tanh suffers from vanishing gradients, but often works better in practice, as its output is zero centered. The softmax function is commonly used in the output layer of classification networks to convert the raw output scores into probabilities. The softmax function is defined as

$$softmax ( {x}_{i} ) = \frac{{e}^{x} i}{{\sum }_{j} {e}^{x} i} .$$

The softmax function ensures the outputs sum to 1, making it suitable for multi-class classification tasks.

The floating-point activation vector 230 includes values from applying an activation function(s) to outputs from the previous layer of the neural network.

The MAC 250 combines its inputs (the constrained weights vector 223 and the floating-point input activation vector 230) and sums the products of the combined inputs to produce a summed value. In some embodiments, the summed value is not in a floating-point form, but a lower precision representation of the sum of inputs. This is discussed in more detail in FIG. 4.

In one embodiment, the MAC 250 combines the constrained weights vector 223 and the floating-point activation input vector 230 in a dot product mathematical operation. Within the MAC function 255, the elements of the floating-point activation input vector 230 and the elements of the constrained weights vector 223 are combined. For example, if the floating-point input activation vector 230 contains the elements a₁, a₂, a₃, a₄ and the constrained weights vector 223 has the values w₁, w₂, w₃, w₄ the accumulation function may output the weighted sum as z=w₁·a₁, w₂·a₂, w₃·a₃, w₄·a₄. The sum z represents the pre-activation value of the neuron which will later be passed through an activation function. More detail regarding the accumulator function is discussed with FIG. 4.

Within the MAC function 255, the floating-point values may be cast to fixed-point values. The output of the MAC 250 may be re-quantized to a floating-point format. The output from the MAC 250 can be fed to the floating-point quantizer 260 to enable this change back to floating-point representations. The floating-point quantizer 260 can re-quantize the output from the MAC function 255 (which may not be in a floating-point format) using the same constraint and zero point used during quantization. The integer format of the sum from the MAC function 255 is converted back to a floating-point value, or the re-quantized floating-point representation 270, that approximates the original accumulated value, allowing the neural network to operate in a floating-point domain. Re-quantization from the floating-point quantizer 260 can be adaptive, meaning that different layers or operations may use different constraint factors to maintain precision. Re-quantization may result in a loss of precision due to the delicacy of the process of re-representing an accumulated value from the MAC 250. Precision loss can be minimized by the floating-point quantizer 260 using well-calibrated scaling factors. By converting the quantized MAC 250 output back into a floating-point form, the output quantization turns the high-precision value from the accumulator into a re-quantized lower-precision output representation. This helps the network maintain higher accuracy in critical layers without compromising the overall computational efficiency achieved through quantization.

The MAC 250 uses a higher precision format that may be approximated by quantization. In some embodiments, an integer Kulisch accumulator is assumed and produces an exact precision format.

FIG. 3 illustrates a flowchart 300 of generating an input vector of constrained weights for the MAC.

At block 310 the target constraint identifier 280 identifies the target accumulator bit width 245 and the known data format of the floating-point activation vector 230 to determine a constraint for the exponent value constrainer 210 and the mantissa value constrainer 215 to apply to the floating point weights vector 220.

In QAT, the neural network is trained to handle the reduced precision of computations during inference, including reduced precision accumulation. This provides an improvement in neural networks operating on resource-constrained hardware, or a general improvement in neural network efficiency. The accumulator bit width refers to the number of bits used to add the products from the multiplier and then store the summed values within the accumulator. Detecting or adapting the target accumulator bit width in QAT is pre-determined and configured before training, or the target accumulator bit width 245 and known data format of the floating-point activation vector 230 can be jointly optimized throughout training.

Before the training process begins, the target accumulator bit width can be defined based on the hardware where the model will be deployed. For example, in common hardware accelerators or edge devices, the accumulator might operate at a certain bit width, such as 32 bits, 16 bits, or lower. These devices may use low-precision weights and activations (e.g. 8 bits) to improve efficiency, and the accumulator should still be able to handle the sum of the values within its precision constraints. Thus, during QAT, the network is trained under the assumption that these certain bit widths will be used, allowing it to optimize for the hardware environment.

In contrast to QAT, post-training quantization (PTQ) is applied after a model has been fully trained. This technique typically converts a pre-trained model from high-precision floating-point precision to lower precision without end-to-end retraining, although some training might be performed. For example, fine-tuning rounding functions or quantization parameters may be further trained via stochastic gradient descent.

In some embodiments, the system described herein is a PTQ system.

Knowing the datatypes and size of dot products, a Kulisch accumulator can be designed to accommodate exact results, enabling the avoidance of overflow. The proposed weight containment technique allows the size of this accumulator to be reduced, and hence the hardware investment, without compromising arithmetic results.

Through arithmetic manipulation, the following constraints can be derived to guarantee overflow avoidance when using a signed and identified P-bit accumulator with an input data type that is known to be a floating-point format with subnormals (also known as denormals) and no special value encodings:

$$\vert {a}^{T} u \vert \leq \frac{{2}^{P - 1} - 1}{( {2}^{{M}_{X} + 1} - 1 ) \cdot {2}^{{2}^{{E}_{X - 2}}}}$$

Where x is a vector of floating-point numbers represented with M_{X} mantissa bits and E_{X} exponent bits and w is similarly a vector of floating-point numbers represented with M_{W} mantissa bits and E_{W} exponent bits. It is understood that this bound can be derived via similar arithmetic manipulation for other known data type formats such as micro-scaling data formats, floating-point data formats with special value encodings, or floating-point data formats without subnormals. Furthermore, let m and e be the vector of mantissas and unbiased exponents used to represent weight vector w such that w=m·2^{e-b} where b is the exponent bias typically defined as 2^{E}^{_{W}}⁻¹−1. Furthermore, let a=2^{e} and u=|m|·2^{M}^{_{w}}. It is understood that the signed accumulator can be represented with sign-magnitude or two's compliment formats.

Additionally, in some embodiments, the formulation ignores special values in the floating-point representation such as Not-a-Number (NaN) or infinite values, improving the efficiency of the representations, as the highest exponent can be used to represent numbers. This is common practice in low-precision floating-point formats, where representation efficiency is extremely important. The resulting simplified data type is also a natural fit for quantized floating-point neural networks. These networks have no semantic role for non-numerical activations and would not produce them in the absence of non-numerical inputs. Also, re-quantization (which is the final part of a quantized activation function in some embodiments) is commonly defined to include range clipping. This can be interpreted as an output saturation, which obsoletes the need for representing overflows and, hence, infinities.

At block 320, the exponent value constrainer 210 calculates the exponent values of the weights of the floating-point weights vector based on the target accumulator bit width 245 and known data format of the floating-point activations vector 230. This is described in FIG. 2. At block 330 the mantissa value constrainer 215 calculates the mantissa values for the weights of the floating-point weights vector based on the target accumulator bit width 245 and the known data format of the floating-point activations vector 230.

In floating-point representations, weights are stored using a combination of a mantissa and exponent. Constraining the exponent value and mantissa value of floating-point weights in neural networks can limit the representational range with which weights are represented and processed.

The target accumulator bit with value can determine the range of values a weight can represent.

When the exponent value is constrained, the model's weights represent values within a narrower range. This forces the neural network to learn representations that are robust to a limited range of weights. During QAT, this is done by scaling, shifting, rounding, and clipping the weights to simulate lower bit widths while constraining their norms during training. By doing so, the network learns to operate using learned constraints, making it more efficient during deployment. In PTQ, the training of the model is intended to be minimally affected, as quantization is applied after training. This reduces training overhead as PTQ does not further train or fine-tune the model.

The mantissa value can determine the granularity of weights represented within the given range. Constraining the mantissa value can involve reducing the number of significant digits used to represent the weights. For example, moving from a 32-bit floating-point format (FP32) to a 16-bit floating-point format (FP16) cuts the number of bit width half. Constraining the bit width often reduces memory usage and computation time, as fewer bits are used to represent each weight.

However, lower precision can introduce quantization errors, where weights are rounded to the nearest reasonable value within the constrained precision. This can lead to small inaccuracies in the computations performed by the network. Despite this, neural networks can be more resilient to such errors when trained with quantization-aware techniques or directly calibrated for lo- precision data formats via post-training quantization (PTQ).

In one embodiment, a family of quantization methods allowing the constraint of floating-point quantized weights during calibration, so that the use of a signed P-bit Kulisch accumulator can be used during inferences, is implemented. Using Hölder's inequality, the previously explained identity can be extended to the following:

$${‖ a ‖}_{p} \cdot {‖ u ‖}_{q} \leq \frac{{2}^{P - 1} - 1}{( {2}^{{M}_{X} + 1} - 1 ) \cdot {2}^{{2}^{E} X - 2}} where \frac{1}{p} + \frac{1}{q} = 1 .$$

Other variants of this algorithm can also be applied where a relationship between the first arbitrary norm and the second arbitrary norm of the constrained values weight that align with a mathematical identity.

However, controlling both the constraint of the exponent and the mantissa, especially during calibration, is a highly nontrivial problem, both during quantization-aware training (QAT) or post-training quantization (PTQ). In one embodiment, the problem is approached by introducing a hard constraint, or a maximum mantissa value limit, on ∥u∥₁ while applying a soft constraint, or an inclusive exponent value limit on ∥a∥_{∞}. To do so, we strictly control the l₁−norm of u while adding a regularization penalty to encourage a low l_{∞}−norm of a. As previously mentioned, other variants can exist that use for instance ∥a∥₂ and ∥u∥₂.

In another embodiment, ∥w·2^{M}^{_{W}}^{+b}∥₁ can be directly constrained, which is equivalent to |a^{T}u|.

Because M_{w} and b are defined a priori, this would generalize to the following:

$${‖ w ‖}_{1} \leq \frac{{2}^{P - 1} - 1}{( {2}^{{M}_{X} + 1} - 1 ) {2}^{{2}^{E} X - 1 + {M}_{W} + b}}$$

This method exposes an opportunity to control the accumulator bit width with a dual norm formulation where the mantissas and exponents are separately balanced.

In another embodiment, given an input tensor x that is quantized to M_{X} mantissa bits and E_{X} exponent bits, the weights w are constrained so that a P-bit Kulisch accumulator can be used for the dot product x^{T}w without overflow, underflow, or rounding errors. The re-parameterization of the network weights wis relied on, such that

$$w = g \cdot \frac{v}{{‖ v ‖}_{q}}$$

where g is a learnable scalar and v is a learnable vector and q is defined from the above as q=1.

An accumulator-aware floating-point quantizer can then be implemented as

$${log}_{2} ( ss ) = max ( ⌈ {log}_{2} ( \frac{\vert v \vert}{s} ) ⌉ , 1 - b ) - {M}_{W} ,$$

where ┌x┐ is a strictly positive scaling factor and b is the standard IEEE bias defined as b=2^{E}^{_{w}}⁻¹−1. Building from the upper bound presented, a can be defined such that

$$a = ⌈ {log}_{2} ( \frac{\vert v \vert}{s} ) ⌉ + b - 1 .$$

In certain embodiments, the quantization operator Q(w) can be detailed as:

$$Q ( w ) := s \cdot clip ( ss \cdot ⌈ \frac{w}{s s ⋅ s} ⌉ ; {q}_{min} , {q}_{max} )$$

where the closed interval [qₘᵢₙ, qₘₐₓ] is the range of the floating-point data type used for w. It can be assumed that, qₘₐₓ=−qₘᵢₙ=(2−2−^{M}^{_{w}})·2^{E}^{_{w}}^{-b-1}.

To constrain the l₁−norm of u, the quantizer can be written as

$$w = min ( \frac{g ,}{ss \cdot s} \frac{T}{{‖ a ‖}_{p}} ) \cdot \frac{v}{{‖ v ‖}_{q}} where T = \frac{{2}^{P} - 2}{( {2}^{{M}_{X} + 1} - 1 ) \cdot {2}^{{2}^{{E}_{X}}}} and \frac{1}{p} + \frac{1}{q} = 1 .$$

During QAT or PTQ an lₚ−norm regularization penalty on a₁ can be added for each layer l in a network with L layers. The regularization penalty can be defined as

$${L}_{reg} = {\sum }_{i = 1}^{L} {‖ {a}_{l} ‖}_{p}$$

to encourage lower norms on all aₗ.

FIG. 4 illustrates the components of the MAC function 255 of the MAC 250.

As mentioned above, the MAC 250 can be a Kulisch accumulator. A Kulisch accumulator is a specialized form of an accumulator designed for high-precision accumulation of products, commonly used in quantized or low-precision arithmetic environments. Unlike standard accumulators that might accumulate a fixed precision (such as 32-bit or 16-bit), the Kulisch accumulator accumulates in much larger internal precision, often using integers. This approach allows the precise accumulation of products of low-precision numbers (such as 8-bit floating-point numbers) without losing accuracy due to rounding errors during the accumulation process.

The Kulisch accumulator works by accumulating the full-precision results of multiplication before applying quantization or rounding. For example, a Kulisch accumulator is designed to handle a large number of floating-point products with high precision. It works by storing intermediate results in a large, fixed-point register that avoids precision loss during the accumulation process. When multiplying two floating-point numbers, the products are treated as integers, and the exponents are adjusted accordingly. The large fixed-point register ensures that there is no overflow or rounding error during accumulation, even with a large number of operations.

For example, when multiplying two small floating-point numbers repeatedly and summing the results, the Kulisch accumulator ensures that precision isn't lost after many iterations. Instead of directly summing floating-point products, the Kulisch accumulator keeps a highly accurate running total in a fixed-point format, ensuring no rounding errors throughout calculation.

Within the MAC 250 is the MAC function 255, containing a floating-point multiplier 410, a fixed-point converter 420 and a fixed-point accumulator 430.

The floating-point multiplier receives the constrained weights vector 223 and the floating-point activations vector 230 as discussed in FIG. 2. The function of the floating-point multiplier 410 multiplies the constrained mantissas of the weight and activation values to compute a core product, and adds the constrained exponents of the weight and activation values to determine the exponent of the resulting product. This operation allows the resulting value to cover a wide dynamic range without a loss of precision, meaning the floating-point multiplier 410 can handle small or large numbers effectively.

Once the floating-point product is calculated via the floating-point multiplier 410, the fixed-point accumulator transforms the product of the constrained weights and activations (which could still be in a floating-point format) into an accurate fixed-point representation. The fixed-point representation represents numbers using a fixed number of bits for both the integer and factional parts.

Using fixed-point arithmetic after floating-point multiplication can offer improvements in computational efficiency. Fixed-point operations may be faster and less resource-intensive compared to floating-point operations of similar size as they can be executed more easily by hardware such as digital signal processors (DSPs) or application-specific integrated circuits (ASICs). This is beneficial for tasks such as inference on mobile devices where power and memory resources are limited.

In the MAC 250, the fixed-point converter 420 ensures the products of the weights and activations can be summed efficiently using fixed-point arithmetic. This offers improvements to the system's accuracy when accumulating a large number of small values, as the fixed-point format simplifies and speeds up the accumulation operation in the fixed-point accumulator 430 of the accumulation function. Using floating-point accumulators, the accumulation of small values onto an accumulator that has grown large becomes unlikely due to alignment and precision limitations. A wide Kulisch accumulation prevents destructive exponent alignment.

After the fixed-point conversion by the fixed-point converter 420, the fixed-point accumulator 430 sums the converted values from the fixed-point converter 420. Fixed-point accumulation is more straightforward on hardware as it avoids complexities associated with handling floating-point exponents and mantissas. The accumulated value outputted by the fixed-point accumulator 430 is received as input by the floating-point quantizer 260 as discussed in FIG. 2. The floating-point quantizer 260 uses the floating-point converter 440 functionality to convert the accumulated fixed-point value received back into a floating-point format.

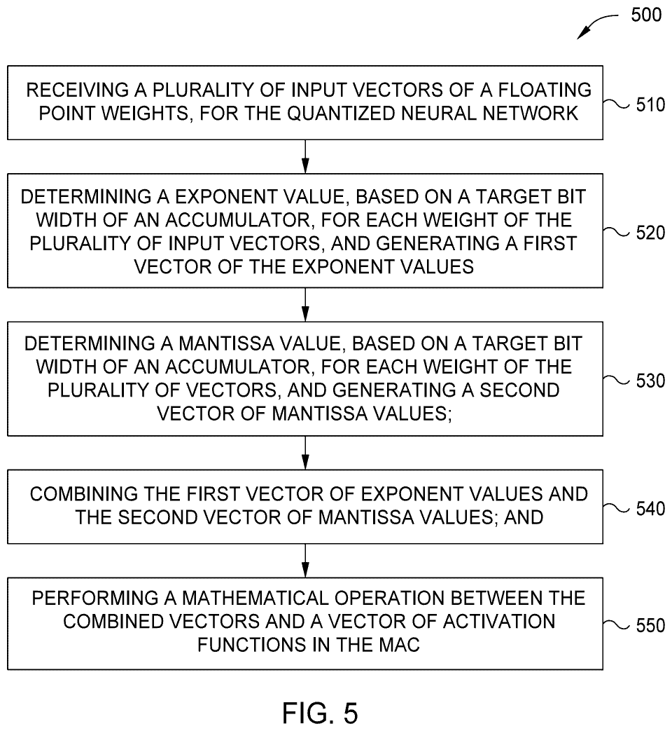

FIG. 5 illustrates a flowchart 500 of the quantization process.

At block 510, the accumulator receives a plurality of input vectors of floating-point weights for the quantized neural network. As discussed in FIG. 2, the accumulator receives weights as input. The received floating-point weights have been constrained according to the bit width of the accumulator used and the known data format of the input activations vector.

At block 520, a constraint value for the exponent values of the exponent values vector is determined based on the target bit width of the accumulator and known data format of the input activations vector.

At block 530, a constraint value for the mantissa values of the mantissa values vector is determined based on the target bit width of the accumulator and known data format of the input activations vector.

At block 540, the system combines the first vector of exponent values and the second vector of mantissa values.

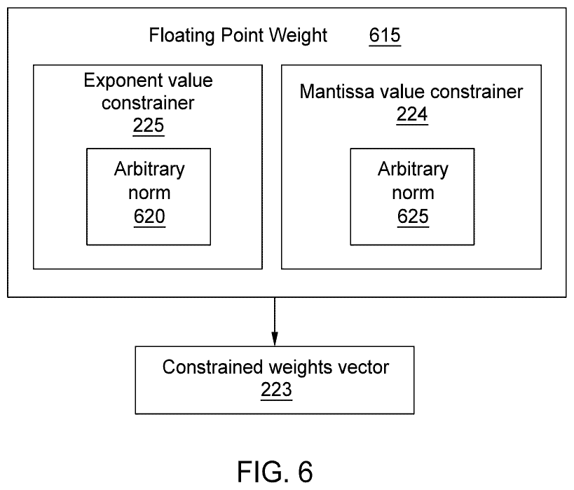

Constraining the weights in a neural network by limiting the mantissa and exponent values of their floating-point representations creates a constrained weights vector. The constrained weights vector contains weight values represented by the exponent values vector and mantissa values vector. Effectively constraining the mantissa and exponent values, as discussed, a more compact and efficient representation of the weights can be achieved. Certain embodiments regarding achieving a balance between constraining the two values is discussed in FIG. 6.

At block 550, the floating point multiplier performs a mathematical operation on the combined vectors received as input.

Within the accumulator's accumulation function, a floating-point multiplier receives the constrained weights vector and the floating-point activation vector (which corresponds to the activations in the neural network). As previously discussed, the weights vector includes both exponent values and the mantissa values. The floating-point multiplier performs element-wise multiplication between the corresponding elements of the weights and activations.

Each multiplication can involve multiplying the constrained mantissas of the floating-point numbers and adding the exponents, ensuring that the result maintains both the precision and scale of the input values. This produces a new floating-point product for each pair of values.

Once the floating-point products are calculated, they are passed to a fixed-point converter. The converter is responsible for transforming the floating-point products into a fixed-point format, which is a calculation that involves scaling the floating-point numbers according to their exponents and rounding or truncating the mantissas to fit the limited precision of the fixed-point representation. The mantissa is shifted according to the exponent of the floating-point value so as to align with desired fixed-point output format. The output format can be wide enough so that rounding and truncation can be prevented. The converter ensures the results fit within the fix point bit width.

After the fixed-point conversion, the resulting fixed-point values are passed to the fixed-point accumulator. This accumulator sums the fixed-point values generated in the previous step. Since fixed-point addition is computationally simpler and faster than floating-point addition, this step is optimized for hardware accelerators or other low-power devices.

During the accumulation process, the fixed-point accumulator sums the values in sequence, ensuring the values are combined accurately. Issues such as overflow and rounding errors are addressed in FIG. 2, as the scale values and the precision values of the weights vector are constrained.

Once the accumulation is complete, in some embodiments, the fixed-point accumulator outputs the final accumulated value in a fixed-point representation. This fixed-point representation of the accumulated result can then be converted back to a floating-point format.

FIG. 6 depicts the operations of the mantissa value constrainer 224 and the exponent value constrainer 225 on a floating-point weight 615 of the floating-point weights vector 220. As described in FIG. 3, the exponent value constrainer 225 and the mantissa value constrainer 224 may achieve applying the appropriate constraint by controlling the arbitrary norm 620 of the scale value of the weight and the arbitrary norm 625 of the precision value of the weight.

The constrained weight, constrained using the methods previously described being that a constrained scaled value is derived, and a constrained precision value is derived, is inputted to the constrained weights vector 223.

As previously mentioned, the constrained weights vector 223 that includes the constrained floating-point weights is mathematically combined (e.g. via a dot product operation) with the floating-point activation vector within the accumulator.

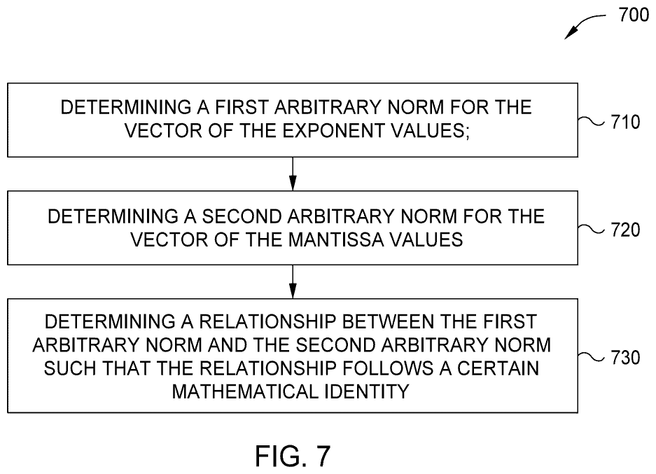

FIG. 7 illustrates a flow chart of constraining an arbitrary norm of the scale and precision values of the weight of the weight vector.

At block 710, the exponent value constrainer 210 determines a first arbitrary norm to apply to the derived vector of exponent values.

At block 720, the system a second arbitrary norm to apply to the derived vector of mantissa values.

At block 730, the system determines a relationship between the first arbitrary norm and the second arbitrary norm such that the relationship follows (the weight aligns with) a certain mathematical identity, such as Holder's inequality.

The blocks of the method 700 correspond to the blocks of the method 300.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
receiving a plurality of input vectors of floating-point weights for a quantized neural network;
determining an exponent value, based on a target bit width of an accumulator and a known data format used for a vector of activation values, for each weight of the plurality of input vectors, and generating a first vector of the exponent values;
determining a mantissa value, based on a target bit width of the accumulator, and the known data format used for the vector of activation values, for each weight of the plurality of vectors, and generating a second vector of mantissa values;
combining the first vector of exponent values and the second vector of mantissa values; and
performing a mathematical operation between the combined vectors and the vector of activation values in a MAC unit.

2. The method of claim 1, further comprising:
determining a first arbitrary norm for each exponent value of the vector of the exponent values;
determining a second arbitrary norm for each mantissa value of the vector of mantissa values; and
determining a relationship between the first arbitrary norm and the second arbitrary norm of each exponent value and each mantissa value of each weight that aligns with a mathematical identity.

3. The method of claim 2, wherein the mathematical identity is Holder's inequality.

4. The method of claim 1, further comprising:
applying a constraint determined by the target bit with of the accumulator and the known data format used for the vector of activation values, to mantissa values of the floating-point weights and exponent values of the floating-point weights, wherein the known data format for the vector of activation values comprises of a floating-point format with known mantissa and exponent bit widths.

5. The method of claim 4, wherein constraining the mantissa values comprises applying a maximum mantissa value limit, and wherein constraining the exponent values comprises applying an inclusive exponent value limit.

6. The method of claim 1, wherein special values are not encoded in a floating-point weight data format, wherein the special values comprise:
a non-numerical value; or
an infinity value.

7. The method of claim 1, wherein the vector of activation values comprises values constrained to fit within a set range.

8. The method of claim 1, wherein the accumulator is a Kulisch accumulator.

9. The method of claim 1, wherein the mathematical operation comprises multiplying the combined vectors and the vector of activation.

10. A system comprising:
one or more processors; and
one or more memories configured to store an application, which, when executed by a combination of the one or more processors, causes the combination of the one or more processors to perform an operation, the operation comprising:
receiving a plurality of input vectors of floating-point weights for a quantized neural network;
determining an exponent value, based on a target bit width of an accumulator and a known data format used for a vector of activation values, for each weight of the plurality of input vectors, and generating a first vector of the exponent values;
determining a mantissa value, based on a target bit width of the accumulator and the known data format used for the vector of activation values, for each weight of the plurality of vectors, and generating a second vector of mantissa values;
combining the first vector of exponent values and the second vector of mantissa values; and
performing a mathematical operation between the combined vectors and a vector of activation values in the accumulator.

11. The system of claim 10, further comprising:
determining a first arbitrary norm for each exponent value of the vector of the exponent values;
determining a second arbitrary norm for each mantissa value of the vector of mantissa values; and
determining a relationship between the first arbitrary norm and the second arbitrary norm of each exponent value and each mantissa value of each weight that aligns with a mathematical identity.

12. The system of claim 11, wherein the mathematical identity is Holder's inequality.

13. The system of claim 10, further comprising:
applying a constraint determined by the target bit with of the accumulator and the known data format used for the vector of activation values, to mantissa values of the floating-point weights and exponent values of the floating-point weights, wherein the known data format for the vector of activation values comprises of a floating-point format with known mantissa and exponent bit widths.

14. The system of claim 13, wherein constraining the mantissa values comprises applying a maximum mantissa value limit, and wherein constraining the exponent values comprises applying an inclusive exponent value limit.

15. The system of claim 10, wherein special values are not encoded in a floating-point data format, wherein the special values comprise:
a non-numerical value; or
an infinity value.

16. The system of claim 10, wherein the vector of activation values comprises values constrained to fit within a set range.

17. The system of claim 10, wherein the accumulator is a Kulisch accumulator.

18. The system of claim 10, wherein the mathematical operation comprises multiplying the combined vectors and the vector of activation.

19. A computer-readable storage medium having computer-readable program code embodied therewith, the computer-readable program code executable by one or more computer processors to:
receive a plurality of input vectors of floating-point weights for a quantized neural network;
determine an exponent value, based on a target bit width of an accumulator, and a known data format used for a vector of activation values, for each weight of the plurality of input vectors, and generating a first vector of the exponent values;
determine a mantissa value, based on a target bit width of the accumulator and the known data format used for the vector activation values, for each weight of the plurality of vectors, and generating a second vector of mantissa values;
combine the first vector of exponent values and the second vector of mantissa values; and
perform a mathematical operation between the combined vectors and the vector of activation values in a MAC unit.

20. The computer-readable program code of claim 19, further comprising:
determining a first arbitrary norm for each exponent value of the vector of the exponent values;
determining a second arbitrary norm for each mantissa value of the vector of mantissa values; and
determining a relationship between the first arbitrary norm and the second arbitrary norm of each exponent value and each mantissa value of each weight that aligns with a mathematical identity.
